(19) United States
(12) Patent Application Publication
(10) Pub. No.: US 2011/0144221 A1
(43) Pub. Date: Jun. 16, 2011

(54) Extruded Polystyrene Foam Containing Propylene Carbonate, Ethylene Carbonate or Butylene Carbonate as a Process Aids

(75) Inventors: Yadollah Delaviz, Lewis Center, OH (US); Raymond Marshall Breindel, Hartville, OH (US); Mitchell Z. Weekley, Tallmadge, OH (US)

(73) Assignee: OWENS CORNING INTELLECTUAL CAPITAL, LLC, Toledo, OH (US)

(21) Appl. No.: 12/996,032

(22) PCT Filed: Jun. 4, 2008
(86) PCT No.: PCT/US2008/065780

§ 371 Date: Feb. 28, 2011

(51) Int. Cl. C08J 9/00; B82Y 30/00

(52) U.S. Cl. 521/79; 521/97; 521/88; 977/773; 977/742

(57) ABSTRACT

Polymeric foam and polymeric foam products that contain a foamable polymer material, at least one hydrofluorocarbon (HFC) blowing agent, an infrared attenuating agent such as nanographite, and propylene carbonate, ethylene carbonate, or butylene carbonate as a process additive are provided. In one or more embodiments, the HFC blowing agent is 1,1-difluoroethane (HFC-152a), 1,1,1,2-tetrafluoroethane (HFC-134a), or a combination of 1,1-difluoroethane (HFC-152a) and 1,1,1,2-tetrafluoroethane (HFC-134a). The propylene carbonate, ethylene carbonate, or butylene carbonate acts as a cell enlarger to increase the average cell size of the foamed product, as a process aid, as a plasticizer, and lowers the die pressure. The inventive foam composition produces extruded foams that have insulation values (R-values) that are equal to or better than conventional extruded, closed cell foams produced with 1-chloro-1,1-difluoroethane (HCFC-142b). In exemplary embodiments, less than 4% of the cells are open cells. A method of forming an extruded foam product is also provided.

### TECHNICAL FIELD AND INDUSTRIAL APPLICABILITY OF THE INVENTION

The present invention relates generally to extruded foam products, and more particularly, to a polystyrene foam containing at least one hydrofluorocarbon (HFC) blowing agent, one or more infrared attenuating agents (IAA), and propylene carbonate to increase insulating capability and decrease thermal conductivity in a foamed product. A method of forming such polymer foams is also provided.

### BACKGROUND OF THE INVENTION

Foamed resinous structures are useful in a wide variety of applications such as thermal insulation, in cushions, as packaging, and as adsorbents. Extruded foams are generally made by melting a polymer together with any desired additives to create a polymer melt. A blowing agent is mixed with the polymer melt at an appropriate temperature and pressure to produce a foamable gel mixture. The foamable gel mixture is then cooled and extruded into a zone of reduced pressure, which results in a foaming of the gel and the formation of the desired extruded foam product. As will be appreciated, the relative quantities of the polymer(s), blowing agent(s), and additives, as well as the temperature and manner in which the pressure is reduced will tend to affect the qualities and properties of the resulting foam product.

Traditional blowing agents used for extruded foam products include chlorofluorocarbons (CFCs) and hydrochlorofluorocarbons (HCFCs). One of the advantages of both CFC and HCFC blowing agents is their high solubility in a polymer melt during the manufacturing process. Higher blowing agent solubility promotes a reduction in viscosity when the blowing agent is mixed with the polymer melt. In turn, lower viscosity leads to lower energy requirements for mixing. On the other hand, a major disadvantage to these traditional blowing agents is that an increasing number of governments worldwide have mandated the elimination of CFC and HCFC blowing agents due to growing environmental concerns. CFCs, and many other halocarbons, have come to be recognized as serious global environmental threats due to their ability to cause stratospheric ozone depletion and global warming. The ozone depletion and global warming impact of chemicals such as CFCs and HCFCs are measured by the ozone depletion potential (ODP) and global warming potential (GWP) respectively.

In view of the mandatory phase out of blowing agents with a high ODP and a high GWP, there has been a movement to replace the conventional blowing agents with more environmentally friendly blowing agents, such as hydrofluorocarbons (HFCs) and CO₂, in insulating foam applications. Although HCFCs provide a superior thermal barrier compared to HFC and CO₂, the chlorine present in the HCFCs possesses an ozone depletion potential. Additionally, over time, the chlorofluorocarbon gas phase remaining in the foam is released into the atmosphere, thereby reducing the insulative value of the foam and potentially further contributing to the global warming potential. In addition, each of the “non-conventional” blowing agents leads to a different cell size and morphology, depending on the particular blowing agent chosen. Additionally, the cell sizes of the foams produced by these generally environmentally friendly blowing agents are too small to provide an acceptable insulative value to the foamed product and generally results in a higher density and a more costly product. For instance, HFC-134a is much less soluble in a polystyrene melt than HCFC-142b. A, HFC-134a produces foams with a small cell size, which creates difficulty in processing compared to HCFC-142b.

To reduce thermal conductivity and increase the insulative value of the foamed product, infrared attenuating agents (IAAs) such as carbon black, powdered amorphous carbon, graphite, and titanium dioxide have been used as fillers in polymeric foam products. However, the inclusion of infrared attenuating agents in the foamable composition in combination with HFC blowing agents tends to increase the melt rheology and decrease the cell size of the foam product. Additionally, an undesirable high die pressure is required when such infrared attenuating agents and HFC blowing agents are present.

Despite previous attempts to utilize infrared attenuating agents to improve thermal insulative properties, there remains a need in the art to achieve an extruded polymer foam that has an increased cell size when non-HCFC blowing agents are used, that maintains the positive physical properties of conventional extruded polystyrene foams, and that provides a foam product with increased insulation value (R-value).

### SUMMARY OF THE INVENTION

It is an object of the present invention to provide a composition for forming a closed cell, rigid thermoplastic polymer foam that includes a foamable polymer material, at least one blowing agent selected from hydrofluorocarbons, C₁ to C₉ aliphatic hydrocarbons, C₁ to C₃ aliphatic alcohols, natural gases, and combinations thereof, one or more nanosize infrared attenuating agent, and a processing aid selected from propylene carbonate, ethylene carbonate, butylene carbonate and combinations thereof.

It is also an object of the present invention to provide a composition where the foamable polymer material is present in the composition in an amount from 60% to 95% by weight of the composition, the at least one blowing agent is present in the composition an amount from 0.1% to 12.0% by weight of the composition, the one or more nanosize infrared attenuating agent is present in the composition in an amount from 0.10% to 2.0% by weight of the composition, and the processing aid is present in the composition in an amount from 0.1 to 1.0% by weight of the composition.

It is another object of the present invention to provide a thermoplastic polymer foam product that includes an extruded foamable composition, where the foamable composition includes a foamable polymer material, at least one blowing agent selected from hydrofluorocarbons, C₁ to C₉ aliphatic hydrocarbons, C₁ to C₃ aliphatic alcohols, natural gases and combinations thereof, at least one infrared attenuating agent, and a processing aid selected from propylene carbonate, ethylene carbonate, butylene carbonate and combinations thereof, where the processing aid is present in the composition an amount less than or equal to 2% by weight of the composition.

It is a further object of the present invention to provide a method of forming a rigid, closed cell foam product that includes heating an alkenyl aromatic polymer material and an infrared attenuating agent to a first temperature sufficient to melt the polymer material and form a polymer melt, incorporating a mixture of a blowing agent and a processing aid selected from propylene carbonate, butylene carbonate, and ethylene carbonate into the polymer melt at a first pressure to form a foamable gel, cooling the foamable gel to a second temperature where the second temperature is less than the first temperature, and extruding the cooled polymer melt at a pressure sufficient to form a rigid, closed cell extruded foam product.

It is also an object of the present invention to compound the nanographite in a polyethylene methyl acrylate copolymer prior to the heating step.

It is yet another object of the present invention that the incorporation of the processing aid in the polymer melt results in no compounding of the processing aid.

It is an advantage of the present invention that the propylene carbonate increases the average cell size of the foamed product without detrimentally affecting the physical or thermal properties of the product.

It is another advantage of the present invention that the composition of the present invention has a low global warming potential and little or no ozone depleting potential.

It is also an advantage that the foamable composition is completely non-flammable.

It is yet another advantage of the present invention that the inclusion of the infrared attenuating agent (for example, nanographite) and propylene, ethylene, or butylene carbonate in the foamable composition requires no modification to existing manufacturing equipment and therefore no increase in manufacturing costs.

It is a further advantage of the present invention that the foams produced by the present composition have no toxicity to living creatures.

It is yet another advantage of the present invention that the nanographite assists in improving fire performance properties such as decreasing the flame spread, which helps to meet stringent fire requirements.

It is yet another advantage of the present invention that the polymer processing aid provides a cell size from 0.100 mm to 0.300 mm and an R-value from 5.0-7.0 in the extruded foam product.

It is a feature of the present invention that the propylene carbonate, butylene carbonate, and ethylene carbonate act as plasticizers, reduce the melt viscosity, and lower the extrusion pressures.

It is another feature of the present invention that the inclusion of propylene carbonate greatly improves the solubility of the blowing agent in the polymer melt.

It is a feature of the present invention that the foamable polymer material is an alkenyl aromatic polymer material.

It is yet another feature of the present invention that the foamable polymer material is selected from polyvinyl chloride, chlorinated polyvinyl chloride, polyethylene, propylene, polycarbonates, polyisocyanurates, polyetherimides, polyamides, polyesters, polycarbonates, polymethylmethacrylate, polyurethanes, phenolics, polyolefins, styreneacrylonitrile, acrylonitrile butadiene styrene, acrylic/styrene/acrylonitrile block terpolymer, polysulfone, polyurethane, polyphenylenesulfide, acetal resins, polyamides, polyaramides, polyimides, polyacrylic acid esters, copolymers of ethylene and propylene, copolymers of styrene and butadiene, copolymers of vinylacetate and ethylene, rubber modified polymers, thermoplastic polymer blends, and combinations thereof.

It is a further feature of the present invention that the blowing agent is selected from 1,1-difluoroethane (HFC-152a); 1,1,1,2-tetrafluoroethane (HFC-134a); 1,1,1,2-tetrafluoroethane (HFC-134a)/ethanol; CO₂/ethanol; 1,1,1,2-tetrafluoroethane (HFC-134a)/CO₂/ethanol; carbon dioxide; water and combinations thereof.

It is another feature of the present invention that one infrared attenuating agent is selected from nanographite, carbon black, powdered amorphous carbon, granulated asphalt, asphalt, milled glass, fiber glass strands, mica, black iron oxide, metal flakes, carbon nanofiber, carbon nanotube, activated carbon, titanium dioxide, and combinations thereof.

It is also a feature of the invention that the infrared attenuating agent is a multi-layered nanographite having a thickness in at least one dimension less than 100 nm.

It is another feature of the invention that the processing aid is present in an amount sufficient to disperse, in the absence of a surfactant, the infrared attenuating agent in the composition.

It is a further feature of the present invention that the blowing agent and the processing aid are simultaneously or substantially simultaneously added to the polymer melt.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of an extrusion apparatus for forming an extruded foam according to at least one exemplary embodiment of the invention;

FIG. 2 is a scanning electron micrograph image of foam formed from a foamable composition containing 0.5 wt % nanographite and 0.0% propylene carbonate according to the present invention;

FIG. 3 is a scanning electron micrograph image of foam formed from a foamable composition containing 0.5 wt % nanographite and 1.0 wt % propylene carbonate according to the present invention; and

FIG. 4 is a scanning electron micrograph image of foam formed from a foamable composition containing 0.0% nanographite and 1.0 wt % propylene carbonate according to the present invention.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references. In the drawings, the thickness of the lines, layers, and regions may be exaggerated for clarity. It is to be noted that like numbers found throughout the figures denote like elements. The terms “composition” and “inventive composition” may be used interchangeably herein.

The present invention relates to a polymeric foam and polymeric foam products, such as extruded or expanded polystyrene foams, formed from a composition that contains a foamable polymer material, at least one blowing agent (for example, hydrofluorocarbon (HFC)), an infrared attenuating agent (for example, nanographite), and propylene carbonate, ethylene carbonate, or butylene carbonate as a process additive. In one or more embodiments, the blowing agent is 1,1-difluoroethane (HFC-152a), 1,1,1,2-tetrafluoroethane (HFC-134a), or a combination of 1,1-difluoroethane (HFC-152a) and 1,1,1,2-tetrafluoroethane (HFC-134a). The propylene, ethylene, or butylene carbonate acts as a cell enlarger to increase the average cell size of the foamed product, as a process aid, as a plasticizer, enhances the solubility of the blowing agent (particularly HFC-134a in a polystyrene melt), and lowers the die pressure.

The foamable polymer material is the backbone of the formulation and provides strength, flexibility, toughness, and durability to the final product. The foamable polymer material is not particularly limited, and generally, any polymer capable of being foamed may be used as the foamable polymer in the resin mixture. The foamable polymer material may be thermoplastic or thermoset. The particular polymer material may be selected to provide sufficient mechanical strength and/or to the process utilized to form final foamed polymer products. In addition, the foamable polymer material is preferably chemically stable, that is, generally non-reactive, within the expected temperature range during formation and subsequent use in a polymeric foam. Non-limiting examples of suitable foamable polymer materials include alkenyl aromatic polymers, polyvinyl chloride (PVC), chlorinated polyvinyl chloride (CPVC), polyethylene, polypropylene, polycarbonates, polyisocyanurates, polyetherimides, polyamides, polyesters, polycarbonates, polymethylmethacrylate, polyurethanes, phenolics, polyolefins, styreneacrylonitrile, acrylonitrile butadiene styrene, acrylic/styrene/acrylonitrile block terpolymer (ASA), polysulfone, polyurethane, polyphenylenesulfide, acetal resins, polyamides, polyaramides, polyimides, polyacrylic acid esters, copolymers of ethylene and propylene, copolymers of styrene and butadiene, copolymers of vinylacetate and ethylene, rubber modified polymers, thermoplastic polymer blends, and combinations thereof.

In one embodiment, the foamable polymer material is an alkenyl aromatic polymer material. Suitable alkenyl aromatic polymer materials include alkenyl aromatic homopolymers and copolymers of alkenyl aromatic compounds and copolymerizable ethylenically unsaturated comonomers. In addition, the alkenyl aromatic polymer material may include minor proportions of non-alkenyl aromatic polymers. The alkenyl aromatic polymer material may be formed of one or more alkenyl aromatic homopolymers, one or more alkenyl aromatic copolymers, a blend of one or more of each of alkenyl aromatic homopolymers and copolymers, or blends thereof with a non-alkenyl aromatic polymer. Notwithstanding the components of the composition, the alkenyl aromatic polymer material may include greater than 50 or greater than 70 weight percent alkenyl aromatic monomeric units. In at least one embodiment of the invention, the alkenyl aromatic polymer material is formed entirely of alkenyl aromatic monomeric units.

Examples of alkenyl aromatic polymers include, but are not limited to, those alkenyl aromatic polymers derived from alkenyl aromatic compounds such as styrene, α-methylstyrene, ethylstyrene, vinyl benzene, vinyl toluene, chlorostyrene, and bromostyrene. In at least one embodiment, the alkenyl aromatic polymer is polystyrene.

Minor amounts of monoethylenically unsaturated compounds such as C₂ to C₆ alkyl acids and esters, ionomeric derivatives, and C₂ to C₆ dienes may be copolymerized with alkenyl aromatic compounds. Non-limiting examples of copolymerizable compounds include acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene.

The foamed products may be formed substantially of (for example, greater than 95 percent), and in most embodiments, formed entirely of polystyrene. The foamable polymer material may be present in the composition in an amount from 60% to 95% by weight, in an amount from 80% to 90% by weight, or in an amount of 85% to 90% by weight. As used herein, the term “% by weight” is meant to indicate a percentage based on 100% total weight of the composition.

It is to be appreciated that the properties of the extruded foam or foam product may be modified by the selection of the molecular weight of the polymer. For example, the preparation of lower density extruded foam products is facilitated by using lower molecular weight polymers. On the other hand, the preparation of higher density extruded foam products is facilitated by the use of higher molecular weight polymers or higher viscosity resins.

The foamable composition may include at least one hydrofluorocarbon (HFC) blowing agent. The specific hydrofluorocarbon utilized is not particularly limited. A non-exhaustive list of examples of suitable blowing HFC blowing agents include 1,1-difluoroethane (HFC-152a), 1,1,1,2-tetrafluoroethane (HFC-134a), 1,1,1-trifluoroethane (HFC-143a), difluoromethane (HFC-32), 1,3,3,3-pentafluoropropane (HFO-1234ze), pentafluoro-ethane (HFC-125), fluoroethane (HFC-161), 1,1,2,2,3,3-hexafluoropropane (HFC 236ca), 1,1,1,2,3,3-hexafluoropropane (HFC-236ea), 1,1,1,3,3,3-hexafluoropropane (HFC-236fa), 1,1,1,2,2,3-hexafluoropropane (HFC-245ca), 1,1,2,3,3-pentafluoropropane (HFC-245ea), 1,1,1,2,3 pentafluoropropane (HFC-245eb), 1,1,1,3,3-pentafluoropropane (HFC-245fa), 1,1,1,4,4,4-hexafluorobutane (HFC-356mff), 1,1,1,3,3-pentafluorobutane (HFC-365mfc), and combinations thereof. Organic blowing agents suitable for use in the present invention include, but are not limited to, C₁ to C₉ aliphatic hydrocarbons (for example, methane, ethane, propane, n-butane, cyclopentane, isobutane, n-pentane, isopentane, and neopentane), C₁ to C₃ aliphatic alcohols (for example, methanol, ethanol, n-propanol, and isopropanol). A co-blowing agent such as alcohol (for example, ethanol), dimethyl ether, trans-dichloroethene (TDCE), and/or water may be used in addition to one or more of the organic blowing agents. Further, combinations of blowing agents such as HFC-134a/ethanol, CO₂/ethanol, HFC-134a/CO₂/ethanol may be used as the blowing agent in the instant invention. Natural gases such as carbon dioxide (CO₂), nitrogen (N₂), and/or argon (Ar) may also be used as a blowing agent. In exemplary embodiments, the blowing agent includes at least one hydrofluorocarbon (HFC) blowing agent.

The blowing agent(s) may be present in the composition in an amount from 0.1% to 12.0% by weight. In one exemplary embodiment, the blowing agent is present in an amount from 2.0% to 10.0% by weight. The blowing agent utilized in the inventive composition is selected such that the composition has zero ozone depletion and low to no global warming potential. In at least one exemplary embodiment, the blowing agent is 1,1-difluoroethane (HFC-152a), 1,1,1,2-tetrafluoroethane (HFC-134a), or a combination of 1,1-difluoroethane (HFC-152a) and 1,1,1,2-tetrafluoroethane (HFC-134a). In another embodiment, the blowing agent is a 50:50 weight ratio of 1,1-difluoroethane (HFC-152a) and 1,1,1,2-tetrafluoroethane (HFC-134a).

As discussed above, the composition also contains at least one infrared attenuating agent (IAA) to increase the R-value of the foam product. Hydrofluorocarbon blowing agents, while environmentally friendly, tend to decrease the R-value of the foam product compared to a conventional HCFC foamed product (for example, R-value per inch of 5.0). It was discovered, however, that the addition of low levels of an infrared attenuating agent to a foamable composition containing a hydrofluorocarbon blowing agent increased the R-value of the foam to an amount comparable to, or better than, a foam produced with an HCFC blowing agent (for example, 1-chloro-1,1-difluoroethane (HCFC-142b)). It was discovered that, generally, foams produced with an infrared attenuating agent and a hydrofluorocarbon blowing agent had an R-value per inch of 5.0. Although the infrared attenuating agent increases the R-value for foams that include hydrofluorocarbon blowing agents, the addition of infrared attenuating agents also tends to decrease the cell size of the cells in the foam, which results in undesirable final foamed products. In particular, small cell sizes tend to increase board bulk density, increase product cost, and reduce the process window during the extrusion process. Further, infrared attenuating agents undesirably increase the melt rheology, which will result in an increase of the die pressure.

Non-limiting examples of suitable infrared attenuating agents for use in the present composition include nanographite, carbon black, powdered amorphous carbon, asphalt, granulated asphalt, milled glass, fiber glass strands, mica, black iron oxide, metal flakes (for example, aluminum flakes), carbon nanotube, nanographene platelets, carbon nanofiber, activated carbon, titanium dioxide, and combinations thereof. In exemplary embodiments, the infrared attenuating agent is present in the foam composition in an amount from 0.10% to 2.0% by weight of the total composition. In other embodiments, the infrared attenuating agent may be present in an amount from 0.5 to 3.0% by weight, from 0.5 to 2.0% by weight, from 0.5 to 1.0% by weight, or from 0.1 to 1.0% by weight. In some exemplary embodiments, the infrared attenuating agent is present in the composition in an amount less than or equal to 0.5% by weight.

In at least one exemplary embodiment, the infrared attenuating agent is nanographite. The nanographite can be multilayered by furnace high temperature expansion from acid-treated natural graphite or microwave heating expansion from moisture saturated natural graphite. In addition, the nanographite may be a multi-layered nanographite which has at least one dimension with a thickness less than 100 nm. In some exemplary embodiments, the graphite may be mechanically treated such as by air jet milling to pulverize the nanographite particles. The pulverization of the particles ensures that the nanographite flake and other dimensions of the particles are less than 150 microns.

The nanographite may not be chemically or surface modified and may be compounded in a polyethylene methyl acrylate copolymer (EMA), which is used both as a medium and a carrier for the nanographite. Other possible carriers for the nanographite include polymer carriers such as, but not limited to, polymethyl methacrylate (PMMA), polystyrene, polyvinyl alcohol (PVOH), and polyvinyl acetate (PVA). In exemplary embodiments, the nanographite is substantially evenly distributed throughout the foam. As used herein, the phrase “substantially evenly distributed” is meant to indicate that the substance (for example, nanographite) is evenly distributed or nearly evenly distributed within the foam.

To compensate for the decreased cell size caused by the infrared attenuating agent and the blowing agent (for example, HFC-134a and/or HFC-152a), propylene carbonate, ethylene carbonate, or butylene carbonate is included in the composition. The chemical structures of propylene carbonate, ethylene carbonate, and butylene carbonate are set forth below as Formulas I-III, respectively.

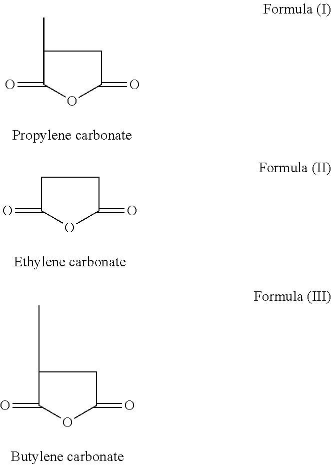

It has been surprisingly discovered that the addition of propylene carbonate, ethylene carbonate, or butylene carbonate has a tremendous affect on the processability of the HFC blowing agent(s) present in the composition. In addition, the propylene, ethylene, or butylene carbonate have been found to offset or regulate the decreased cell size caused by the blowing agent and infrared attenuating agents. Thus, the propylene, ethylene, or butylene carbonate present in the inventive composition acts as a cell enlarger, a viscosity reducer, a plasticizer, and a processing aid. Further, the propylene, ethylene, or butylene carbonate lowers the die pressure significantly (for example, from 76 bars to 55 bars) due, at least in part, to its role as a viscosity reducer. In addition, propylene carbonate, ethylene carbonate, and butylene carbonate are powerful plasticizers in that they lower the melt viscosity, enhance blowing agent solubility, and ease processability. Additionally, the propylene, ethylene, and butylene carbonate disperse the infrared attenuating agent without the need for the inclusion of surfactants. It is to be appreciated that homologs of propylene carbonate, butylene carbonate, and ethylene carbonate may also or alternatively be utilized in the present invention.

The propylene, ethylene, or butylene carbonate may be added to the composition in an amount less than or equal to 2% by weight, particularly from 0.5% to 2.0% by weight, and in exemplary embodiments, from 0.1 to 1.0% by weight or from 0.5 to 1.0% by weight. In other embodiments, the propylene, ethylene, or butylene carbonate may be present in an amount from 0.01% to 10.0% by weight, from 0.01% to 5.0% by weight, or from 0.5% to 3.0% by weight.

The use of propylene, butylene, or ethylene carbonate in conjunction with the infrared attenuating agent permits the formation of a foam with an optimal cell size in order to achieve a high insulation value (R-value) and to optimize the physical properties of the final foamed product. In addition, propylene, butylene, or ethylene carbonate provides an increased cell size to the foamed product without detracting from the physical and thermal properties the foam. Also, the addition of propylene, ethylene, or butylene carbonate to the composition provides a smoother surface and minimal or no surface defects to the extruded, foamed product, especially when compared to conventional foamed products using HCFC as a blowing agent.

In general, propylene carbonate and its homolog series are fairly polar compounds due to the presence of —COO— moieties in their structures. As a result, propylene carbonate, ethylene carbonate, and butylene carbonate add hydrophilicity or polarity to the polymer melt (for example, polystyrene melt). Such a change in the polarity of the polymer melt makes the melt more attractive to blowing agents such as HFCs (for example, HFC-134a and HFC-152a) and CO₂. The similarity between a portion of the structure of propylene carbonate and the molecular structure of CO₂ enhances the solubility of the blowing agent in the polymer melt. In addition, the increase in hydrophilicity in the polymer melt caused by the propylene, ethylene, or butylene carbonate makes the polymer matrix (for example, polystyrene and propylene carbonate) more attractive to water vapor and therefore increases water vapor permeability of the foamed product.

Further, the inventive composition may contain a fire retarding agent in an amount up to 1.0% by weight. For example, fire retardant chemicals may be added in the extruded foam manufacturing process to impart fire retardant characteristics to the extruded foam products. Preferably, the fire retarding agent is added to the foamable gel, which is described below with respect to the formation of the inventive foam. Non-limiting examples of suitable fire retardant chemicals for use in the inventive composition include brominated aliphatic compounds such as hexabromocyclododecane and pentabromocyclohexane, brominated phenyl ethers, esters of tetrabromophthalic acid, and combinations thereof.

Optional additives such as nucleating agents, plasticizing agents, pigments, elastomers, extrusion aids, antioxidants, fillers, antistatic agents, biocides, and/or UV absorbers may be incorporated into the inventive composition. These optional additives may be included in amounts necessary to obtain desired characteristics of the foamable gel or resultant extruded foam products. The additives may be added to the polymer mixture or they may be incorporated in the polymer mixture before, during, or after the polymerization process used to make the polymer.

To form an alkenyl aromatic polymer foam according to the principles of the instant invention, the foamable polymer material (for example, polystyrene) may be heated to a temperature at or above the polymer's glass transition temperature or melting point to form a plasticized or a melt polymer material. The infrared attenuating agent (for example, nanographite) may be blended in the polymer melt or dry blended with the polymer material prior to plasticizing or melting the foamable polymer material. It is to be appreciated that nanographite may also be added directly as a powder, in a compact form, or in a slurry. One or more blowing agents (for example, a blend of 1,1-difluoroethane (HFC-152a) and 1,1,1,2-tetrafluoroethane (HFC-134a)) and propylene carbonate are separately pelletized and then incorporated or mixed into the melt polymer material by any conventional method known to those of skill in the art such as, for example, with an extruder, a mixer, or a blender. As the blowing agent is added to the polymer melt, the blowing agent becomes soluble, that is dissolves, in the polymer melt and forms a foamable gel. Additionally, the blowing agent may be mixed with the melt polymer material at an elevated pressure sufficient to prevent substantial expansion of the melt polymer material and to generally disperse the blowing agent(s) and propylene carbonate homogeneously in the melt polymer material.

The foamable gel may then be cooled to a die melt temperature. The die melt temperature is typically cooler than the melt mix temperature to optimize the physical characteristics of the foamed product. In addition, that the die pressure may be sufficient to prevent, or at least minimize, pre-foaming of the foamable gel. Pre-foaming is the undesirable premature foaming of the foamable gel before extrusion of the gel into a region of reduced pressure. Thus, the die pressure varies depending upon the identity and amount of blowing agent(s) present in the foamable gel. The foamable gel may then be extruded through a die having a desired shape to a zone of lower or reduced pressure to form the desired foamed structure or foamed product. The zone of lower pressure is at a pressure lower than that in which the foamable gel is maintained prior to extrusion through the die. The lower pressure may be superatmospheric or subatmospheric (that is, a vacuum), but in most embodiments, it is at atmospheric level. The foam thus produced is a rigid, closed cell, polymer foam.

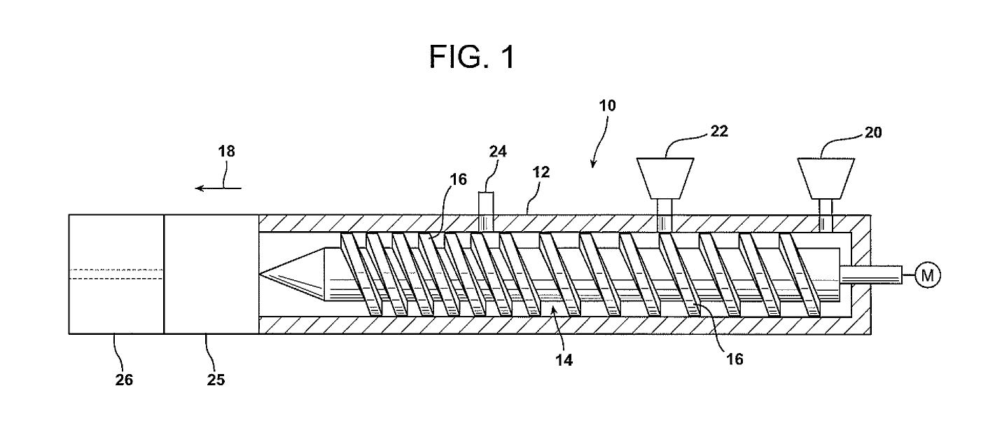

A screw extruder for use in the present invention is generally indicated at reference numeral 10 in FIG. 1. The screw extruder for use in the instant invention may equally be a single screw or twin screw extruder. Reference is made herein with respect to a single screw extruder. The extruder 10 is formed of a barrel 12 and at least one screw 14 that extends substantially along the length of the barrel 12. A motor (M) may be used to power the screw 14. The screw 14 contains helical flights 16 rotating in the direction of arrow 18. The flights 16 of the screw 14 cooperate with the cylindrical inner surface of the barrel 12 to define a passage for the advancement of the resin and reinforcement fibers through the barrel 12. The foamable polymer material may be fed into the screw extruder 10 as flowable solid, such as beads, granules, or pellets from one or more feed hoppers 20.

As the foamable polymer material flows through the extruder 10 in the direction of arrow 18, the spacing between the flights 16 of the screw 14 decreases. Thus, the volume between the flights 16 decreases as the polymer melt flows downstream. The term “downstream” as used herein refers to the direction of resin and fiber flow through the barrel 12. This decreasing volume, together with the mechanical action and friction generated from the barrel 12 and the screw 14, causes the foamable polymer material to melt and form the melt polymer material.

It is to be appreciated that the flights 16 of the screw 14 cooperate with the cylindrical inner surface of the barrel 12 to define a passage for the advancement of the polymer melt through the barrel 12. As shown in FIG. 1, ports are provided at designated positions on the extruder for the insertion of the infrared attenuating agent and the injection of the blowing agent(s), and the propylene carbonate. Specifically, a hopper 22 is provided downstream of the feed hopper 20 to feed the infrared attenuating agent into the barrel 12. The infrared attenuating agent is mixed into the polymer melt by the rotation of the screw 14. It is to be noted, however, that other ports and/or hoppers may be present on the barrel 12 for the inclusion of other materials or additives, such as, but not limited to, flame retardants, nucleating agents (for example, talc), biocides, plasticizing agents, pigments, elastomers, extrusion aids, antioxidants, fillers, and/or antistatic agents.

In at least one embodiment, the blowing agent and the propylene carbonate are substantially simultaneously fed into the barrel 12 of the extruder 10 through a single port 24. As used herein, the term “substantially simultaneously fed” is meant to indicate that the blowing agent(s) and propylene carbonate are fed into the barrel 12 at the same time or at nearly the same time. For ease of discussion, reference will be made herein with respect to the use of propylene carbonate, though ethylene carbonate or butylene carbonate are equally suitably used. It is to be noted that the blowing agent(s) and propylene carbonate are added at a location where the flights 16 of the screw 14 are closer together compared to the location where the infrared attenuating agent is added to the barrel 12. As a result, little or no compounding of the propylene carbonate occurs. Once the infrared attenuating agent, blowing agent(s), and propylene carbonate have been introduced into the barrel 12, the resulting foamable mixture is subjected to additional blending to substantially uniformly distribute the infrared attenuating agent, blowing agent, and propylene carbonate throughout the foamable mixture.

The heat from the internal friction from the screw 14 within the barrel 12 causes the blowing agent to be uniformly or substantially uniformly dispersed for improved solubility. The foamable mixtures is subsequently cooled to a lower temperature in a melt cooler 25 and then conveyed from the extruder 10 through an extrusion die 26 which is designed to shape the foam into a desired shape and to create a pressure drop which permits the blowing agent to expand and develop a foamed cell structure in the form of a foam layer or slab. This area of reduced pressure within the extrusion die may be at or below atmospheric pressure (that is, a vacuum). The polymeric foam may be subjected to additional processing such as calendaring, water immersion, cooling sprays, or other operations to control the thickness and other properties of the resulting foam product.

The foam composition produces rigid, closed cell, polymer foam boards prepared by an extruding process. Extruded foams have a cellular structure with cells defined by cell membranes and struts. Struts are formed at the intersection of the cell membranes, with the cell membranes covering interconnecting cellular windows between the struts. In the present invention, the inventive composition produces substantially closed cellular foams with an average density of 1.0 lbs/ft³ to 5.0 lbs/ft³, or from 1.5 lbs/ft³-3.0 lbs/ft³. It is to be appreciated that the phrase “substantially closed cell” is meant to indicate that the foam contains all closed cells or nearly all of the cells in the cellular structure are closed. In most exemplary embodiments, not more than 5.0% of the cells are open cells or otherwise “non-closed” cells. The closed cell structure helps to increase the R-value of a formed, foamed insulation product. It is to be appreciated, however, that it is within the purview of the present invention to produce an open cell structure, although such an open cell structure is not an exemplary embodiment.

Additionally, the inventive foam composition produces extruded foams that have insulation values (R-values) that are equal to or better than conventional extruded foams produced with 1-chloro-1,1-difluoroethane (HCFC-142b). The R-value per inch of the inventive foams and foam products may be from 5.0-7.0. In at least one embodiment, the R-value per inch is 5.0. In addition, the average cell size of the inventive foam and foamed products is 0.100 mm (100 microns) to 0.300 mm (300 microns) and, in some embodiments, from 0.160 mm (160 microns) to 0.200 mm (200 microns). The extruded inventive foam may be formed into an insulation product such as rigid insulation boards, insulation foam, packaging products, and building insulation or underground insulation (for example, highway, airport runway, railway, and underground utility insulation).

Another aspect of the extruded inventive foams is that they possess a high level of dimensional stability. For example, the change in dimension in any direction is 5% or less. In addition, the foam formed by the inventive composition is desirably monomodal and the cells have a relatively uniform average cell size. As used herein, the average cell size is an average of the cell sizes as determined in the X, Y and Z directions. In particular, the “X” direction is the direction of extrusion, the “Y” direction is the cross machine direction, and the “Z” direction is the thickness. In the present invention, the highest impact in cell enlargement is in the X and Y directions, which is desirable from an orientation and R-value perspective. In addition, further process modifications would permit increasing the Z-orientation to improve mechanical properties while still achieving an acceptable thermal property. The extruded inventive foam can be used to make insulation products such as rigid insulation boards, insulation foam, and packaging products.

There are numerous advantages of utilizing the composition of the present invention to form foam products. For example, the blowing agent utilized in the inventive formulation does not have a high global warming potential and has a low or zero ozone depleting potential. In addition, the infrared attenuating agent and the propylene carbonate may be added to the melt polymer in a conventional fashion. Therefore, in at least some exemplary embodiments, there is no need to modify existing equipment or change the manufacturing lines to accommodate either the infrared attenuating agent or the propylene carbonate. In addition, propylene carbonate is environmentally friendly and does not create any negative environmental concerns. Further, the propylene carbonate increases the average cell size of the foamed product without detrimentally affecting the physical or thermal properties of the product.

Additionally, the propylene carbonate improves the solubility of the blowing agent(s) in the foamable composition, whether it be CO₂, HFC, or blends thereof. The propylene carbonate acts as a plasticizer to reduce the melt viscosity and lower the extrusion pressures. Additionally, the propylene carbonate can advantageously be a substitute for ethanol in a CO₂/ethanol based blowing agent system. The resulting CO₂/propylene carbonate blowing agent system is completely non-flammable, which positively impacts the work environment. In addition, the CO₂/propylene carbonate blowing agent platform has a huge cost savings and environmental impact. For instance, there is no need to invest large capital to upgrade the production lines and equipment to handle flammable, volatile organic compounds (VOC's) that may be emitted from the CO₂/ethanol system, thereby creating a safer, more environmentally friendly workplace. It is believed that propylene carbonate may also be utilized as a substitute for ethanol in a CO₂/ethanol, a HFC-134a/ethanol and/or a HFC-134a/CO₂/ethanol system. The substitution of propylene carbonate transforms the flammable HFC-134a/CO₂/ethanol, CO₂/ethanol, and HFC-134a/ethanol blowing agent platforms into non-flammable systems.

Having generally described this invention, a further understanding can be obtained by reference to certain specific examples illustrated below which are provided for purposes of illustration only and are not intended to be all inclusive or limiting unless otherwise specified.

### EXAMPLES

In the following examples, all foam boards are extruded polystyrene foam boards.

The rigid foam boards were prepared by a twin screw extruder with a flat die and shaper plate and were extruded into an atmospheric or sub-atmospheric zone.

### Example 1

### Effect of Addition of Propylene Carbonate

A series of experiments were conducted in order to investigate the relative performance of foams formed by the inventive composition containing propylene carbonate compared to foams produced with HFC and no propylene carbonate. Compositions containing polystyrene, a 50:50 blend of 1,1-difluoroethane (HFC-152a) and 1,1,1,2-tetrafluoroethane (HFC-134a), nanographite, and propylene carbonate were formed according to the extrusion method described in detail above. In particular, the polystyrene and nanographite were compounded and heated to a melt mixing temperature of approximately 325° F. to form a melt polymer material. The 1,1-difluoroethane (HFC-152a) and 1,1,1,2-tetrafluoroethane (HFC-134a) blend and propylene carbonate and were then simultaneously mixed into the polymer melt at a first pressure from 2850-3300 psi to generally disperse the blowing agent and propylene carbonate homogeneously in the melt polymer material and form a foamable gel. The foamable gel was then cooled to a temperature from 240° F.-370° F. The foamable gel was extruded in a twin screw extruder and through a die to a zone of reduced pressure (760-1100 psi) to produce a rigid foam board. Foams produced with no propylene carbonate or no nanographite were produced in a similar manner with the exception that the propylene carbonate and/or the nanographite was excluded from the above-described process. The process conditions are set forth in Table 1.

TABLE 1
Process Conditions

| | |
|---|---|
| Extruder Pressure, psi | 2850-3300 |
| Melt Mixing Temperature (° F.) | 325 +/− 25 |
| Die Melt Temperature (° F.) | 255 +/− 15 |
| Die Pressure, psi | 760-1100 |
| Line Speed, ft/min | 12-22 |
| Throughput, kg/hr | 160 |
| Die Gap, mm | 0.9-2.0 |
| Vacuum, inch Hg | 0-16 |

The effect of propylene carbonate on the foaming process and product properties were measured and recorded. The data is set forth in Table 2.

TABLE 2
Effect of Propylene Carbonate

| | Propylene | | | Die | Average | | Water Vapor |
|---|---|---|---|---|---|---|---|
| | Carbonate | Graphite | Density | Pressure | Cell Size | | Permeability |
| Sample | (%) | (% actual) | (pcf) | (bars) | (mm) | X:Z | (%/inch) |
| 1 | 0.0 | 0.0 | 2.09 | 75.9 | 0.168 | 0.97 | 0.688 |
| 2 | 0.0 | 1.0 | 2.04 | 60.9 | 0.138 | 1.12 | |
| 3 | 1.0 | 0.5 | 2.09 | 54.4 | 0.191 | 1.13 | 0.758 |
| 4 | 1.0 | 1.0 | 2.16 | 58.4 | 0.177 | 1.12 | 0.816 |

Comparing Sample 1 (i.e., the control sample), which contained no propylene carbonate or nanographite, with Sample 2 that contained a 1.0% loading of nanographite and no propylene carbonate, it can be seen that the incorporation of nanographite to the foamable composition decreased the average cell size by an amount of 18% (that is, from 0.168 mm to 0.138 mm). Due to its small particle size, the nanographite acts as a nucleating agent and causes a decrease in cell sizes anywhere from 25 to 50% based on loading of 0.50 to 1.0 wt %, respectively. The optimal cell size for an extruded polystyrene foam is approximately 0.200 mm. The cell size of 0.138 mm produced by Sample 2 is extremely small, and it was observed that Sample 2 did not produce a desirable foamed board. However, it was surprisingly discovered that the incorporation of propylene carbonate in an amount as low as 1.0% by weight into a polymer melt containing 0.5% nanographite (Sample 3) increased the average cell size by an amount of approximately 14% compared to Sample 1 (control). Therefore, it was concluded that the addition of propylene carbonate negated the negative impact in cell size caused by the addition of nanographite.

To further explore the effect of the propylene carbonate, 1.0% nanographite with and without 1.0% propylene carbonate was studied. As shown in Table 2, the foams of Samples 2 and 4 contained 1.0% nanographite with similar densities, but Sample 4, which contained 1.0% propylene carbonate, had a 22% larger average cell size. From this data, it was concluded that the addition or incorporation of propylene carbonate in a foamable composition that contained nanographite caused a significant increase in the cell size of the foam.

Additionally, Table 2 illustrates that the foam of Sample 3 demonstrated an approximate 29% reduction in die pressure compared to the foam of Sample 1, that is, a reduction from 75.9 bars to 54.4 bars. This is a significant improvement as a lower die pressure enables the foam to be easily processed with less energy requirements, which, in turn, results in a wider processing window and an overall improvement in the quality of the foam product. For instance, it was visually observed that samples that contained propylene carbonate had improved foam surface quality. The reduction in die pressure caused by the propylene carbonate is also an indication of propylene carbonate's role as a powerful plasticizer and its ability to increase the solubility of the blowing agents in the polymer melt.

In addition, it was observed that the propylene carbonate improved the water vapor permeability of the foam. Samples that did not contain propylene carbonate, such as Sample 1, had a water vapor permeability of 0.688%/inch. It was observed that when propylene carbonate was included in the composition, the water vapor permeability was improved. For example, Samples 3 and 4, which contained 1.0% by weight propylene carbonate, had an increased water vapor permeability of 0.758 and 0.816%/inch, respectively. Comparing Sample 1 and Sample 3, which both had the same density (that is, 2.09 pcf), there was demonstrated a 10% improvement in water vapor permeability due to the inclusion of 1.0% by weight propylene carbonate.

### Example 2

### Further Effect of Addition of Propylene Carbonate

A second series of experiments were conducted in order to further investigate the effect of propylene carbonate. In these experiments, foams were produced using the process parameters set forth above in Example 1. The amounts of propylene carbonate and nanographite added to the sample compositions are set forth in Table 3.

TABLE 3
Further Effect of Propylene Carbonate

| | Propylene | | | Die | Average | | Water Vapor |
|---|---|---|---|---|---|---|---|
| | Carbonate | Graphite | Density | Pressure | Cell Size | | Permeability |
| Sample | (%) | (% actual) | (pcf) | (bars) | (mm) | X:Z | (%/inch) |
| 5 | 0.0 | 0.5 | 1.77 | 76.5 | 0.174 | 0.94 | 0.731 |
| 6 | 1.0 | 0.5 | 1.91 | 53.1 | 0.188 | 1.08 | 0.836 |
| 7 | 1.0 | 0.0 | 1.77 | 54.6 | 0.211 | 1.10 | 0.795 |

As shown in Table 3, the addition of 1.0% by weight propylene carbonate to the foamable composition lowered the die pressure from 76.5 bars (Sample 5) to 53.1 bars (Sample 6). This reduction of die pressure is an approximate 30% improvement in the processability of the foam. Ease of processability reduces manufacturing costs, reduces waste that may occur due to processing problems, and improves overall foam productivity.

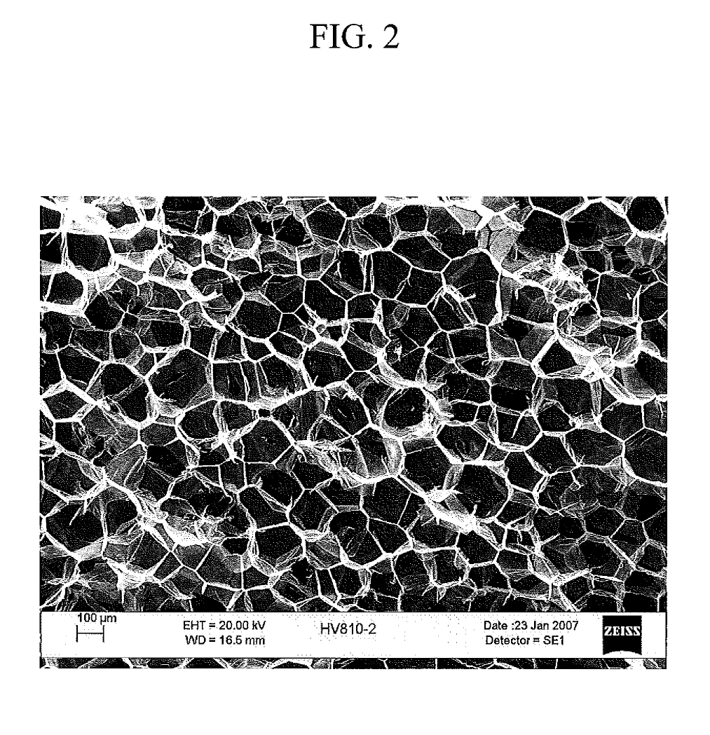

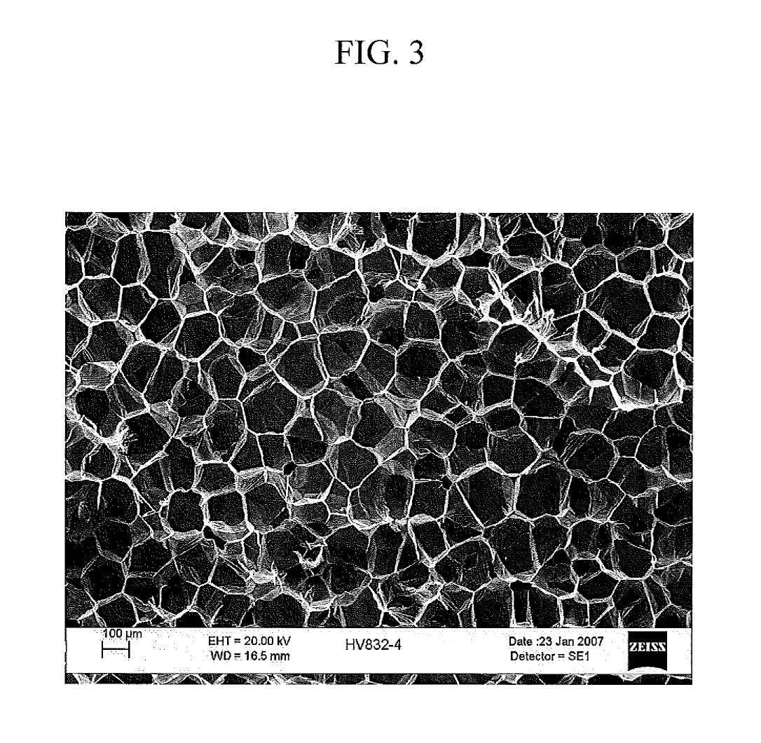

The increase in cell size and the cancellation of the negative effect on cell size by nanographite caused by the inclusion of propylene carbonate to a foamable composition can be seen in FIGS. 2 and 3. FIG. 2 is a scanning electron micrograph (SEM) image of a foam produced by a foamable composition containing 0.5% by weight nanographite and no (that is, 0.0% by weight) propylene carbonate (Sample 5). As shown in FIG. 3 (0.5% by weight nanographite, 1.0% by weight propylene carbonate (Sample 6)), the inclusion of 1.0% by weight of propylene carbonate increased the cell size compared to Sample 5 (FIG. 2). In particular, the cell size increased from 0.174 mm in FIGS. 2 to 0.188 mm in FIG. 3. This is an approximate 8.0% increase in cell size.

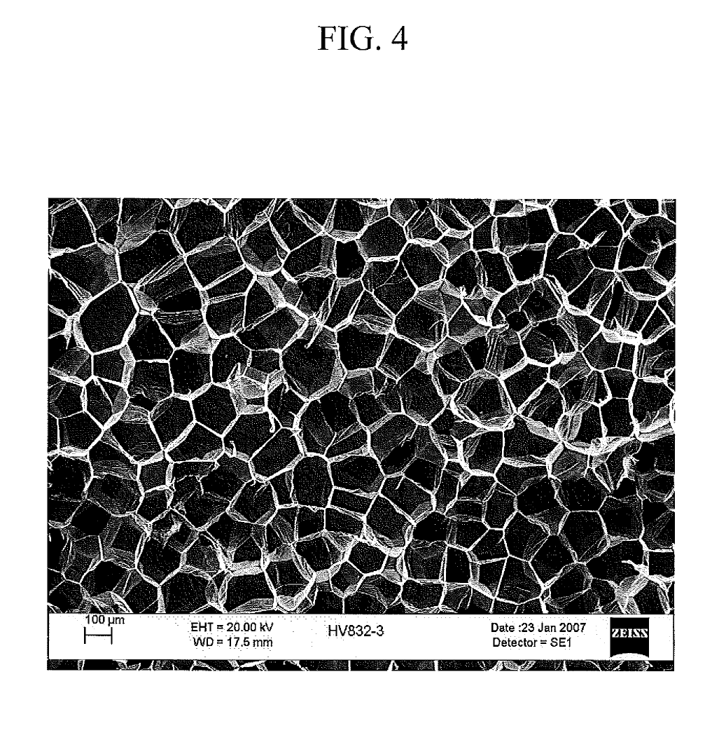

A scanning electron micrograph image of a foam containing 0.0% by weight nanographite and 1.0% by weight propylene carbonate (Sample 7) is depicted in FIG. 4. This micrograph illustrates that propylene carbonate has a much larger effect on cell size in the absence of nanographite. For instance, the average cell size increased from 0.188 mm in Sample 6, which contained 0.5% by weight nanographite, to 0.211 mm in Sample 7 in which no nanographite was present (both contained 1.0% by weight of propylene carbonate). This is a 12% impact on the average cell size. The results set forth in Table 3 also show that the addition of propylene carbonate increased the water vapor permeability of the foam board.

From the experiments conducted in Examples 1 and 2, it was concluded that the inclusion of propylene carbonate in an amount as low as 1.0% to a foamable composition has significant impact on the processability and product properties. Specifically, the propylene carbonate surprisingly and unexpectedly improved the surface quality of the foamed product, significantly increased the cell size of the foam, improved water permeability, and reduced die pressures. In addition, the inclusion of propylene carbonate greatly improved the solubility of the blowing agent in the polymer melt.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

1. A composition for forming a closed cell, rigid thermoplastic polymer foam comprising:
a foamable polymer material;
at least one blowing agent selected from hydrofluorocarbons, C₁ to C₉ aliphatic hydrocarbons, C₁ to C₃ aliphatic alcohols, natural gases, water and combinations thereof;
one or more nanosize infrared attenuating agent; and
at least one processing aid selected from propylene carbonate, ethylene carbonate, butylene carbonate and homologs thereof.

2. The composition of claim 1, wherein said foamable polymer material is an alkenyl aromatic polymer material.

3. The composition of claim 2, wherein said foamable polymer material is selected from polyvinyl chloride, chlorinated polyvinyl chloride, polyethylene, polypropylene, polycarbonates, polyisocyanurates, polyetherimides, polyamides, polyesters, polycarbonates, polymethylmethacrylate, polyurethanes, phenolics, polyolefins, styreneacrylonitrile, acrylonitrile butadiene styrene, acrylic/styrene/acrylonitrile block terpolymer, polysulfone, polyurethane, polyphenylenesulfide, acetal resins, polyamides, polyaramides, polyimides, polyacrylic acid esters, copolymers of ethylene and propylene, copolymers of styrene and butadiene, copolymers of vinylacetate and ethylene, rubber modified polymers, thermoplastic polymer blends and combinations thereof.

4. The composition of claim 2, wherein said blowing agent is selected from 1,1-difluoroethane (HFC-152a); 1,1,1,2-tetrafluoroethane (HFC-134a); 1,1,1,2-tetrafluoroethane (HFC-134a)/ethanol; CO₂/ethanol; 1,1,1,2-tetrafluoroethane (HFC-134a)/CO₂/ethanol; carbon dioxide; water and combinations thereof.

5. The composition of claim 2, wherein said infrared attenuating agent is a multi-layered nanographite having a thickness in at least one dimension less than 100 nm.

6. The composition of claim 2, wherein
said foamable polymer material is present in said composition in an amount from 60% to 95% by weight of said composition,
said at least one blowing agent is present in said composition an amount from 0.1% to 12.0% by weight of said composition,
said one or more nanosize infrared attenuating agent is present in said composition in an amount from 0.10% to 2.0% by weight of said composition, and
said at least one processing aid is present in said composition in an amount from 0.1% to 1.0% by weight of said composition.

7. The composition of claim 1, wherein said processing aid is present in said composition in an amount sufficient to disperse said infrared attenuating agent in said composition in the absence of a surfactant.

8. A thermoplastic polymer foam product comprising:
an extruded foamable composition, said foamable composition including:
a foamable polymer material;
at least one blowing agent selected from hydrofluorocarbons, Cᵢ to C₉ aliphatic hydrocarbons, C₁ to C₃ aliphatic alcohols, natural gases and combinations thereof;
at least one infrared attenuating agent; and
one or more processing aids selected from propylene carbonate, ethylene carbonate, butylene carbonate and homologs thereof, said processing aid being present in said composition an amount less than or equal to 2% by weight of said composition.

9. The thermoplastic polymer foam product of claim 8, wherein said at least one blowing agent is selected from 1,1-difluoroethane (HFC-152a); 1,1,1,2-tetrafluoroethane (HFC-134a); 1,1,1,2-tetrafluoroethane (HFC-134a)/ethanol; CO₂/ethanol; 1,1,1,2-tetrafluoroethane (HFC-134a)/CO₂/ethanol; carbon dioxide; water and combinations thereof.

10. The thermoplastic polymer foam product of claim 9, wherein said at least one infrared attenuating agent is selected from nanographite, carbon black, powdered amorphous carbon, granulated asphalt, asphalt, milled glass, fiber glass strands, mica, black iron oxide, metal flakes such as aluminum flakes, carbon nanofiber, carbon nanotube, activated carbon, titanium dioxide and combinations thereof

11. The thermoplastic polymer foam product of claim 10, wherein said at least one infrared attenuating agent is a multi-layered nanographite having a thickness in at least one dimension less than 100 nm.

12. The thermoplastic polymer foam product of claim 9, wherein said foamable polymer material is an alkenyl aromatic polymer material.

13. The thermoplastic polymer foam product of claim 8, wherein said polymer processing aid provides a cell size from 0.100 mm to 0.300 mm and an R-value from 5.0 to 7.0 in said polymer foam product.

14. A method of forming a rigid, closed cell foam product comprising:
heating at least one alkenyl aromatic polymer material and at least one infrared attenuating agent to a first temperature sufficient to melt said at least one polymer material and form a polymer melt;
incorporating a mixture of one or more blowing agents and at least one processing aid selected from propylene carbonate, butylene carbonate, ethylene carbonate and homologs thereof into said polymer melt at a first pressure to form a foamable gel;
cooling said foamable gel to a second temperature, said second temperature being less than said first temperature; and
extruding said cooled polymer melt at a pressure sufficient to form a rigid, closed cell extruded foam product.

15. The method of claim 14, wherein said one or more blowing agents is selected from 1,1-difluoroethane (HFC-152a); 1,1,1,2-tetrafluoroethane (HFC-134a); 1,1,1,2-tetrafluoroethane (HFC-134a)/ethanol; CO₂/ethanol; 1,1,1,2-tetrafluoroethane (HFC-134a)/CO₂/ethanol; carbon dioxide; water and combinations thereof.

16. The method of claim 15, wherein said at least one infrared attenuating agent is nanographite.

17. The method of claim 16, wherein further comprising:
compounding said nanographite in a polyethylene methyl acrylate copolymer prior to said heating step.

18. The method of claim 15, wherein said one or more blowing agents and said at least one processing aid are simultaneously or substantially simultaneously added to said polymer melt.

19. The method of claim 18, wherein said incorporation of said at least one processing aid in said polymer melt results in no compounding of the processing aid.

20. The method of claim 15, wherein said at least one processing aid provides a cell size from 0.100 mm to 0.300 mm and an R-value from 5.0-7.0 in said extruded foam product.
